(19) United States
(12) Patent Application Publication
(10) Pub. No.: US 2024/0005625 A1
(43) Pub. Date: Jan. 4, 2024

(54) IMAGE PROCESSING METHOD AND APPARATUS, ELECTRONIC DEVICE AND STORAGE MEDIUM

(71) Applicant: GOERTEK INC., Shandong (CN)

(72) Inventors: Chen CHEN, Shandong (CN); Bin JIANG, Shandong (CN); Xiaoyu CHI, Shandong (CN)

(73) Assignee: GOERTEK INC., Shandong (CN)

(21) Appl. No.: 18/253,580

(22) PCT Filed: Sep. 30, 2021
(86) PCT No.: PCT/CN2021/122092

§ 371 Date: May 18, 2023

(30) Foreign Application Priority Data
Nov. 23, 2020 (CN) 202011321093.X

(51) Int. Cl. G06V 10/25; G06T 7/194; G06T 7/20; G06T 9/00

(52) U.S. Cl. CPC G06V 10/25; G06T 7/194; G06T 7/20; G06T 9/00; G06V 2201/07

(57) ABSTRACT

An image processing method and apparatus, an electronic device and a storage medium are disclosed. The method comprises: acquiring a current frame of image; detecting a moving object in the current frame of image to obtain a region of interest and a background region, wherein the region of interest includes the moving object; compressing image data of the region of interest to obtain first image data after compressed; and outputting the first image data after compressed and background picture data corresponding to the background region to a display device to display the current frame of image by the display device.

### CROSS-REFERENCE TO RELATED APPLICATIONS

This application is a U.S. National-Stage entry under 35 U.S.C. § 371 based on International Application No. PCT/CN2021/122092, filed Sep. 30, 2021 which was published under PCT Article 21(2) and which claims priority to Chinese Application No. 202011321093.X, filed Nov. 23, 2020, which are all hereby incorporated herein by reference in their entirety.

### TECHNICAL FIELD

This application pertains to the field of image processing technology. More specifically, the present disclosure relates to an image processing method and apparatus, an electronic device and a storage medium.

### BACKGROUND

Virtual Reality (VR) is a technology emerged recently. With the vigorous development of the virtual reality industry, the demand for interaction between virtual and reality in the process of use for user is increasing quickly.

With the gradual enrichment of VR content, there are higher requirements for the processing performance of VR devices. However, the hardware MIPI transmission bandwidth and CPU/GPU processing speed of existing VR devices have certain limitations. The frame rate of VR devices is relatively low, generally at 60 Hz or 90 Hz. When displaying dynamic pictures by existing VR devices, the low frame rate of VR devices will cause users to feel dizzy to VR motion image display and affect the user experience.

Therefore, it is necessary to provide a new image processing method to improve the frame rate of VR devices, reduce the user's dizziness to VR motion image display, and improve the user experience. In addition, other objects, desirable features and characteristics will become apparent from the subsequent summary and detailed description, and the appended claims, taken in conjunction with the accompanying drawings and this background.

### SUMMARY

The object of the present disclosure is to provide an image processing solution.

According to a first aspect of the present disclosure, an image processing method is provided, which comprises:
acquiring a current frame of image;
detecting a moving object in the current frame of image to obtain a region of interest and a background region, wherein the region of interest includes the moving object;
compressing image data of the region of interest to obtain first image data after compressed; and
outputting the first image data after compressed and background picture data corresponding to the background region to a display device to display the current frame of image by the display device.

Optionally, the step of compressing the image data of the region of interest to obtain the first image data after compressed comprises:
acquiring a target compression ratio;
compressing the image data of the region of interest according to the target compression ratio to obtain the first image data after compressed.

Optionally, the step of acquiring the target compression ratio comprises:
determining the target compression ratio according to a preset compression ratio.

Optionally, the step of acquiring the target compression ratio comprises:
determining the target compression ratio according to a moving speed of the moving object.

Optionally, the target compression ratio comprises a transverse compression ratio and a longitudinal compression ratio, and the step of compressing the image data of the region of interest according to the target compression ratio to obtain the first image data after compressed comprises:
compressing the image data of the region of interest according to the transverse compression ratio and the longitudinal compression ratio to obtain the first image data after compressed.

Optionally, the step of compressing the image data of the region of interest to obtain the first image data after compressed comprises:
extracting a plurality of pixel points in the region of interest according to a preset extraction rule; and
determining image data of the plurality of pixel points as the first image data after compressed.

Optionally, after outputting the first image data after compressed and background picture data corresponding to the background region to a display device to display the current frame of image by the display device, the method further comprises:
acquiring a next frame of image;
detecting the moving object in the next frame of image to obtain a region of interest and a background region, wherein the background region of the next frame of image is consistent with the background region of the current frame of image, and the moving object in the region of interest of the next frame of image changes;
compressing image data of the region of interest of the next frame of image to obtain second image data after compressed; and
outputting the second image data after compressed to the display device to display the next frame of image by the display device.

According to a second aspect of the present disclosure, an image processing apparatus is provided, which comprises:
an image acquisition module for acquiring a current frame of image;
a detection module for detecting a moving object in the current frame of image to obtain a region of interest and a background region, wherein the region of interest includes the moving object;
a compression module for compressing image data of the region of interest to obtain first image data after compressed; and
an output module for outputting the first image data after compressed and background picture data corresponding to the background region to a display device to display the current frame of image by the display device.

According to a third aspect of the present disclosure, an electronic device is provided, which comprises an image processing apparatus described in the second aspect of the present disclosure.

According to a fourth aspect of the present disclosure, a computer-readable storage medium is provided, on which computer instructions are stored, and the method described in any item of the second aspect is executed when the computer instructions are executed by a processor.

According to the present disclosure, by taking advantage of the characteristic of insensitivity of human eyes to local moving objects, the image data of the region of interest of the current frame of image is compressed, which can reduce the number of pixels of moving objects in the current frame of image, and can reduce the data amount for transmitting one frame of image data without affecting the visual effect of the human eye imaging, so that under the same transmission and processing bandwidth constraints, the display frame rate can be improved, the user's dizziness to VR motion image display can be reduced, and the user experience can be improved.

Other features and advantages of the present disclosure will become clearer by reading the following detailed description of the exemplary embodiments of the present disclosure with reference to the accompanying drawings.

### BRIEF DESCRIPTION OF DRAWINGS

The present invention will hereinafter be described in conjunction with the following drawing figures, wherein like numerals denote like elements, and:

FIG. 1 is a hardware configuration diagram of an electronic device that can be used to implement embodiments of the present disclosure;

FIG. 2 is a flow chart of an image processing method according to an embodiment of the present disclosure;

FIG. 3 is a schematic diagram of a dynamic picture according to an embodiment of the present disclosure;

FIGS. 4a-4c are schematic diagrams of a process of compressing a region of interest according to an embodiment of the present disclosure;

FIG. 5 is a block diagram of the structure of an image processing apparatus according to an embodiment of the present disclosure; and

FIG. 6 is a block diagram of the structure of an image processing apparatus according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The technical solutions in embodiments of the present disclosure will be described below with reference to the drawings in the embodiments of the present disclosure. Obviously, the embodiments as described are merely part of, rather than all, embodiments of the present disclosure. Based on the embodiments of the present disclosure, any other embodiment obtained by a person of ordinary skill in the art without paying any creative effort shall fall within the protection scope of the present disclosure.

The following description of at least one exemplary embodiment is in fact only illustrative, and in no way serves as any restriction on the present disclosure and its application or use.

The techniques, methods and equipment known to a person of ordinary skill in the art may not be discussed in detail. However, when applicable, these techniques, methods and equipment shall be considered as a part of the specification.

In all the examples shown and discussed herein, any specific value should be interpreted as merely illustrative and not as a limitation. Therefore, other examples of the exemplary embodiments may have different values.

It should be noted that similar reference numerals and letters denote similar items in the following drawings. Therefore, once an item is defined in one drawing, it does not need to be further discussed in the subsequent drawings.

<Hardware Configuration>

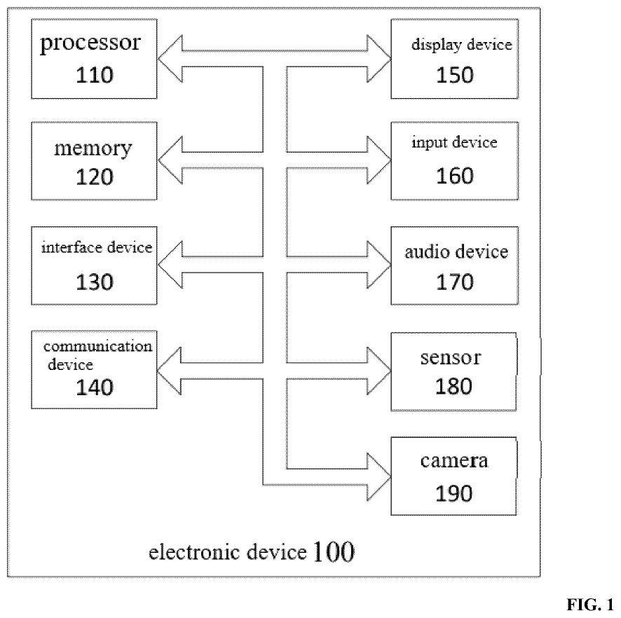

Please refer to FIG. 1, which is a block diagram of the hardware configuration of an electronic device 100 according to an embodiment of the present disclosure.

In the embodiment of the present disclosure, the electronic device 100 may be, for example, a VR (Virtual Reality) device, an AR (Augmented Reality) device, an MR (Mixed Reality) device, etc.

In an embodiment, the electronic device 100 may, as shown in FIG. 1, comprise: a processor 110, a memory 120, an interface device 130, a communication device 140, a display device 150, an input device 160, an audio device 170, a sensor 180, a camera 190, etc.

The processor 110 may include, but is not limited to, a central processor CPU, a microprocessor MCU, etc. The processor 110 may also include an image processor GPU (Graphics Processing Unit), etc. The memory 120 may include, but is not limited to, ROM (read only memory), RAM (random access memory), non-volatile memory such as hard disk, etc. The interface device 130 may include, but is not limited to, a serial bus interface (including USB interface), a parallel bus interface, an infrared interface, etc. The communication device 140 can conduct wired or wireless communication, for example, which includes, but is not limited to, WiFi communication, Bluetooth communication, 2G/3G/4G/5G communication, etc. The display device 150 may be, for example, a liquid crystal display screen, an LED display screen, a touch screen, etc. The input device 160 may include, but is not limited to, a touch screen, a keyboard, a body feeling input, etc. The audio device 170 may be used to input/output voice information. The sensor 180 may be, for example, an image sensor, an infrared sensor, a laser sensor, a pressure sensor, a gyroscope sensor, a magnetic sensor, an acceleration sensor, a distance sensor, a proximity light sensor, an ambient light sensor, a fingerprint sensor, a touch sensor, a temperature sensor, etc. The sensor 180 can be used to measure the posture change of the electronic device 100. The camera 190 may be used to obtain image information.

Although multiple components are shown for the electronic device 100 in FIG. 1, the present disclosure may only involve some of them, for example, the electronic device 100 only involves the processor 110 and the memory 120.

In the above description, technicians can design instructions according to the solutions provided by the present disclosure. How the instruction controls the processor to operate is well known in the art, so it will not be described in detail here.

The electronic device 100 shown in FIG. 1 is only explanatory, and is in no way intended to limit the present disclosure, its application or use.

### Method Embodiment

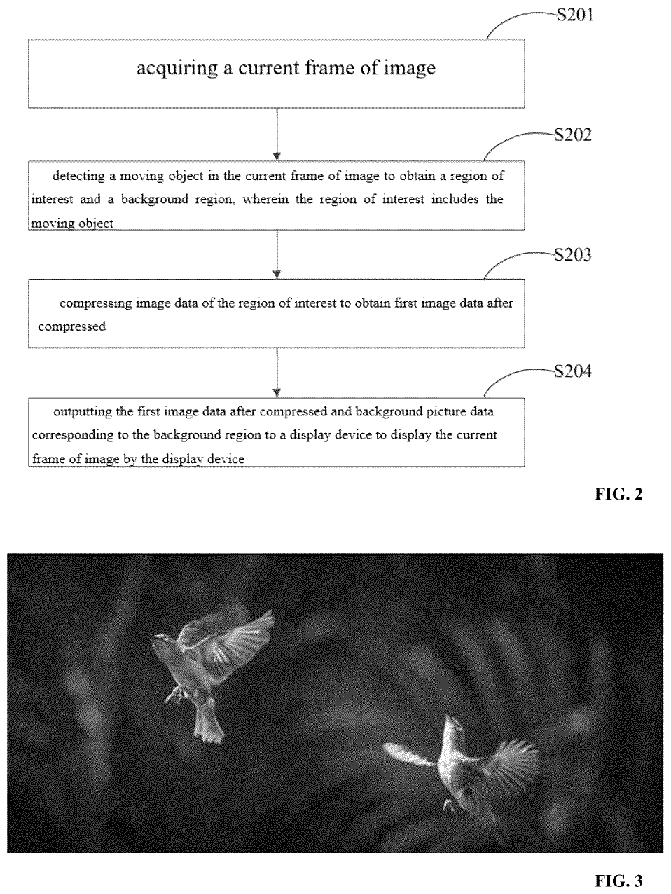

The image processing method according to the embodiment of the present disclosure will be described below with reference to FIG. 2. This method involves an electronic device. The electronic device can be the electronic device 100 as shown in FIG. 1.

The image processing method comprises the following steps S201-S204.
S201. acquiring a current frame of image;

In this embodiment, when presenting a continuous dynamic picture to the user, continuous multiple frames of image may be obtained. Each frame of image in the continuous multiple frames of image comprises a background picture and a moving object. The background picture in each frame of image is basically unchanged. The motion state of the moving object in each frame of image changes continuously.

For example, as shown in FIG. 3, continuous dynamic pictures of a bird flying over the background is presented. For these continuous dynamic pictures, the current frame of image may be, for example, the image when the bird appears in the picture, and the subsequent multiple frames of image may be the continuous multiple frames of image of the bird's flying process.

According to the embodiment of the present disclosure, in combination with the subsequent steps, the region having the moving object of the continuous multiple frames of image is compressed, which can, without affecting the image display effect, reduce the amount of image data, improve the transmission speed, reduce the delay and improve the user experience.
S202. detecting a moving object in the current frame of image to obtain a region of interest and a background region, wherein the region of interest includes the moving object;

The moving object in the current frame of image is identified to obtain the region of interest and the background region. The background region is the background picture. The region of interest includes a moving object. For example, as shown in FIG. 3, the moving object is a bird.

In an embodiment of the present disclosure, the step of identifying a moving object in the current frame of image may comprise: acquiring at least two frames of image that are continuously captured (the two images include a previous frame of image and a current frame of image); comparing the previous frame of image with the current frame of image to identify a changing region in the current frame of image; and taking the changing region as the moving object in the current frame of image.

More specifically, the step of comparing the previous frame of image with the current frame of image to identify the changing region in the current frame of image may comprise: acquiring gray values of the previous frame of image and the current frame of image; calculate a difference of the gray values of the previous frame of image and the current frame of image; when the difference of the gray values reaches a preset change threshold, determining the changing region according to the pixel points corresponding to the difference of the gray values.

It should be noted that the region of interest may be any regular or irregular region. The region of interest may be a square region, a rectangular region, or a circular region. There may be one region of interest or multiple regions of interest.
S203. compressing image data of the region of interest to obtain first image data after compressed;

In this step, the image data of the region of interest of the current frame of image may be compressed according to the target compression ratio, or be compressed according to a preset extraction rule.

The process of compressing the image data of the region of interest of the current frame of image according to the target compression ratio will be described below.

In an embodiment of the present disclosure, the step of compressing the image data of the region of interest to obtain the first image data after compressed comprises S301-S302.
S301. acquiring a target compression ratio;

In a more specific example, the step of acquiring the target compression ratio comprises: determining the target compression ratio according to a preset compression ratio.

In the specific implementation, the preset compression ratio is less than 1. The preset compression ratio may be set according to engineering experience and actual needs. For example, the preset compression ratio may be 1/4.

In another more specific example, the step of acquiring the target compression ratio comprises: determining the target compression ratio according to the moving speed of the moving object.

In this example, the faster the object moves, the more blurred the moving object in the current frame of image is, and the less sensitive the human eye is to the moving object. In the specific implementation, the target compression ratio may be determined according to the moving speed of the moving object. Namely, when the moving speed of the moving object is large, a small target compression ratio, such as 1/6, may be set for the image. When the moving speed of the moving object is small, a large target compression ratio, such as 1/2, may be set for the image. According to the embodiment of the present disclosure, when the moving speed of the moving object is large, a small target compression ratio may be set for the image, which can reduce the number of pixels of local moving objects in the current frame of image, and thus can ensure the display effect of the image while reducing the amount of data in the current frame of image, and improve the user experience. When the moving speed of the moving object is small, a large target compression ratio may be set for the image, so that without affecting the display effect of the image, the number of pixels of local moving objects in the current frame of image can be reduced to a certain extent, thereby reducing the amount of data in the current frame of image and improving the transmission rate.

In still another more specific example, the step of acquiring the target compression ratio comprises: determining the target compression ratio according to a proportion of the region of interest.

In this example, the proportion of the region of interest is the proportion of the region of interest in the current frame of image. For the case where the current frame of image includes one region of interest, the proportion of the region of interest is the proportion of the region of interest in the current frame of image. For the case where the current frame of image includes multiple regions of interest, the proportion of the region of interest is the sum of the proportions of multiple regions of interest in the current frame of image.

In the specific implementation, this step may comprise: acquiring a proportion of the region of interest; comparing the proportion of the region of interest with a preset reference proportion; when the proportion of the region of interest is greater than or equal to the preset reference proportion, taking a first compression ratio as the target compression ratio; when the proportion of the region of interest is less than the preset reference proportion, taking a second compression ratio as the target compression ratio, wherein the second compression ratio is less than the first compression ratio. For example, when the proportion of the region of interest in the current frame of image is greater than or equal to 1/2 (i.e., the reference proportion), the target compression ratio is set to 1/2; when the proportion of the region of interest in the current frame of image is less than 1/2 (i.e., the reference proportion), the target compression ratio is set to 1/4.

According to the embodiment of the present disclosure, the target compression ratio is determined according to the proportion of the region of interest. When the proportion of the region of interest is greater than or equal to the preset reference proportion, a small target compression ratio may be set for the image, which can reduce the number of pixels of local moving objects in the current frame of image, and thus can ensure the display effect of the image while reducing the amount of data in the current frame of image, avoid affecting the image quality due to a large area of the image being compressed, and improve the user experience. When the proportion of the region of interest is less than the preset reference proportion, a large target compression ratio may be set for the image, so that without affecting the display effect of the image, the number of pixels of local moving objects in the current frame of image can be reduced, thereby reducing the amount of data in the current frame of image and improving the transmission rate.

In the specific implementation, the target compression ratio may comprise a transverse compression ratio and a longitudinal compression ratio. The transverse compression ratio and the longitudinal compression ratio may be the same or different. For example, the transverse compression ratio is 1/α; the longitudinal compression ratio is 1/β.
S302. compressing the image data of the region of interest according to the target compression ratio to obtain the first image data after compressed.

In an embodiment of the present disclosure, the target compression ratio comprises a transverse compression ratio and a longitudinal compression ratio.

The step of compressing the image data of the region of interest according to the target compression ratio to obtain the first image data after compressed may further comprise: compressing the image data of the region of interest according to the transverse compression ratio and the longitudinal compression ratio to obtain the first image data after compressed.

By taking advantage of the characteristic of insensitivity of human eyes to local moving objects, the region of interest including a moving object is compressed according to the target compression ratio, which can reduce the amount of data in the image data of the region of interest. In this embodiment, the data amount of the compressed image data of the region of interest (the first image data) is the product of the data amount of the image data of the region of interest before compressed and the target compression ratio. If the target compression ratio is set to be less than 1, the data amount of the compressed image data of the region of interest (the first image data) is less than the data amount of the image data of the region of interest before compressed. Moreover, the smaller the target compression ratio is, the more the data amount of the first image data after compressed is reduced. For example, if the target compression ratio is 1/2, the data amount of the first image data after compressed is 1/2 of the image data of the region of interest before compressed. As another example, if the transverse compression ratio is 1/α, the longitudinal compression ratio is 1/β, the data amount of the first image data after compressed is 1/(α*β) of the data amount of the image data of the region of interest before compressed.

According to the embodiment of the present disclosure, by taking advantage of the characteristic of insensitivity of human eyes to local moving objects, the region of interest including moving objects is compressed according to the target compression ratio, which can reduce the amount of image data in the region of interest, and thus under the same transmission and processing bandwidth constraints, the display frame rate can be improved, and the user's dizziness when using VR devices can be reduced.

The process of compressing the image data of the region of interest of the current frame of image according to the preset extraction rule will be described below.

In an embodiment of the present disclosure, the step of compressing the image data of the region of interest to obtain the first image data after compressed comprises S401-S402.
S401. extracting a plurality of pixel points in the region of interest according to a preset extraction rule;

In the specific implementation, it may be that multiple pixel points are extracted from the region of interest at a preset interval. The preset interval may be, for example, a left-right interval or an up-down interval. For example, multiple pixel points are extracted from the region of interest at an interval of two pixel points in the left-right direction.

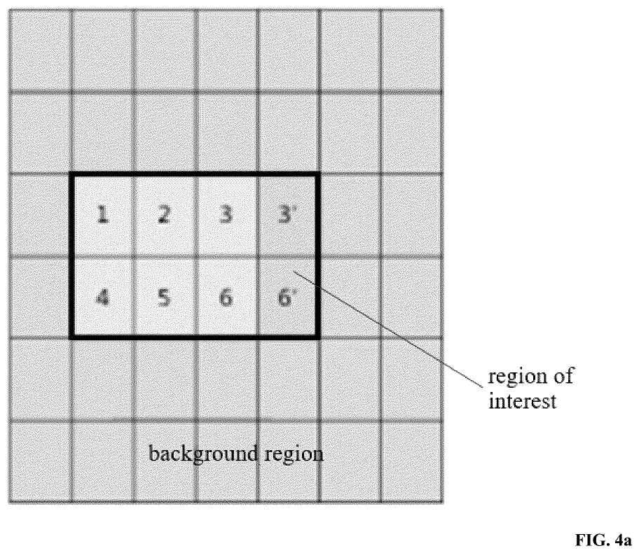

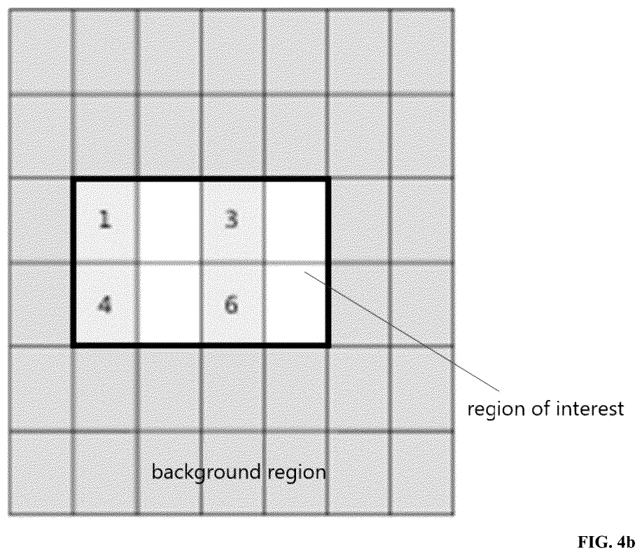

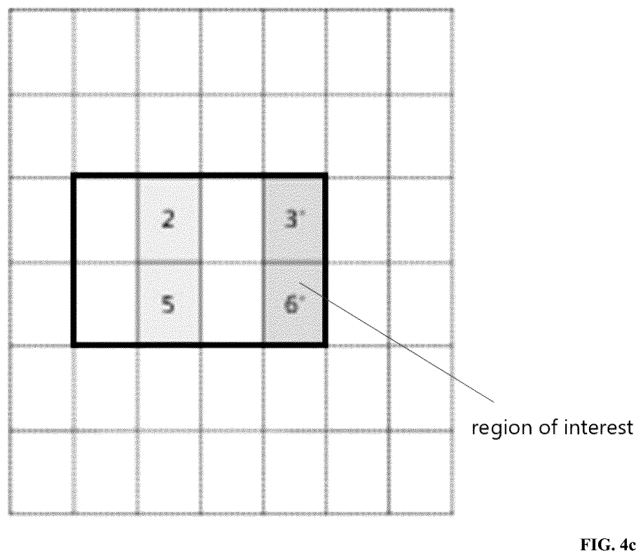

In the specific implementation, it may be that in the region of interest, the pixel points of odd-numbered columns are extracted. Refer to FIG. 4a and FIG. 4b, which show the process of compressing image data of the region of interest in this way. FIG. 4a shows the current frame of image before compressed, which includes a region of interest. FIG. 4b shows the current frame of image after compressed, the region of interest of which includes a pixel point 1, a pixel point 3, a pixel point 4, and a pixel point 6 (i.e., pixel points of odd-numbered columns).

In the specific implementation, it may be that in the region of interest, the pixel points of even-numbered columns are extracted. Refer to FIG. 4a and FIG. 4c, which show the process of compressing image data of the region of interest in this way. FIG. 4a shows the current frame of image before compressed, which includes a region of interest. FIG. 4c shows the current frame of image after compressed, the region of interest of which includes a pixel point 1′, a pixel point 3′, a pixel point 4′, and a pixel point 6′ (i.e., pixel points of even-numbered columns).
S402. determining image data of the plurality of pixel points as the first image data after compressed.

By taking advantage of the characteristic of insensitivity of human eyes to local moving objects, the region of interest including moving objects is compressed according to the target compression ratio, which can reduce the amount of data in the image data of the region of interest.

According to the embodiment of the present disclosure, by taking advantage of the characteristic of insensitivity of human eyes to local moving objects, multiple pixel points are extracted from the region of interest according to the preset extraction rule, and the image data of multiple pixel points is determined as the first image data after compressed, which can reduce the number of pixels the region of interest of the current frame of image, and thus can reduce the amount of data of the image data of the region of interest, so that thus under the same transmission and processing bandwidth constraints, the display frame rate can be improved, and the user's dizziness when using VR devices can be reduced.

After the step of compressing the image data of the region of interest to obtain the first image data after compressed, proceed to the step S204.
S204. outputting the first image data after compressed and background picture data corresponding to the background region to a display device to display the current frame of image by the display device.

For continuous multiple frames of image including a moving object, after processing the current frame of image, the image processing method may further comprise the following steps S501-S504.
S501. acquiring a next frame of image;
S502. detecting the moving object in the next frame of image to obtain a region of interest and a background region, wherein the background region of the next frame of image is consistent with the background region of the current frame of image, and the moving object in the region of interest of the next frame of image changes;

Each frame of image of the continuous multiple frames of image comprises a background picture and a moving object. The background picture in each frame of image is substantially unchanged. The motion state of the moving object in each frame of image changes continuously. In other words, the background picture of the next frame of image is substantially the same as the background picture of the current frame of image, while the motion state of the moving object in the next frame of image is different from the motion state of the moving object in the current frame of image. For example, as shown in FIG. 3, the motion state of the bird (the moving object) in the current frame of image is shown in the right picture, and the motion state of the bird in the next frame of image is shown in the left picture.
S503. compressing image data of the region of interest of the next frame of image to obtain second image data after compressed;

Since the background region of the next frame of image is consistent with the background region of the current frame of image, when processing the next frame of image, only the image data of the region of interest of the next frame of image may be compressed, which can further reduce the data amount of the image data to be transmitted.
S504. outputting the second image data after compressed to the display device to display the next frame of image by the display device.

In this step, the second image data after compressed, i.e., the image data of the region of interest of the next frame of image after compressed, is output to the display device, and the display device can update the moving object in the display image, i.e., display a continuous dynamic picture for the user.

According to the embodiment of the present disclosure, by taking advantage of the characteristic of insensitivity of human eyes to local moving objects, the image data of the region of interest of the current frame of image is compressed, which can reduce the number of pixels of moving objects in the current frame of image, and can reduce the data amount for transmitting one frame of image data without affecting the visual effect of the human eye imaging, so that under the same transmission and processing bandwidth constraints, the display frame rate can be improved, the user's dizziness to VR motion image display can be reduced, and the user experience can be improved.

According to the embodiment of the present disclosure, when presenting continuous dynamic pictures to the user, the image data of the region of interest of the next frame of image is compressed, and only the compressed image data of the region of interest is output, which can further reduce the number of pixels of the image, and can reduce the data amount for transmitting continuous multiple frames of image data without affecting the visual effect of the human eye imaging, so that under the same transmission and processing bandwidth constraints, the display frame rate can be improved, the user's dizziness to VR motion image display can be reduced, and the user experience can be improved.

The processing of continuous frames of image will be described below using a specific example.

Continuous multiple frames of image, which specifically includes a first frame of image, a second frame of image, a third frame of image, . . . , an (n−1)th frame of image, and an nth frame of image, are acquired. The background picture of each frame of image is substantially the same, and the motion state of the moving object in each frame of image changes.

The image data of the region of interest is compressed according to the transverse compression ratio 1/α and the longitudinal compression ratio 1/β. Specifically, it comprises the following steps:
acquiring the first frame of image and processing the first frame of image. Specifically, the image data of the region of interest of the first frame of image is compressed, and the compressed image data is 1/(α*β) of the image data before compressed. The compressed image data and the background picture data corresponding to the background region are output to the display device, so that the display device can display the current picture (the first frame of image);
acquiring the second frame of image and processing the second frame of image. Specifically, the image data of the region of interest of the second frame of image is compressed, and the compressed image data is 1/(α*β) of the image data before compressed. The compressed image data is output, so that the display device can display the next picture (the second frame of image);
acquiring the (n−1)th frame of image and processing the (n−1)th frame of image. Specifically, the image data of the region of interest of the (n−1)th frame of image is compressed, and the compressed image data is 1/(α*β) of the image data before compressed. The compressed image data is output, so that the display device can display the next picture (the (n−1)th frame of image);
acquiring the nth frame of image and processing the nth frame of image. Specifically, the image data of the region of interest of the nth frame of image is compressed, and the compressed image data is 1/(α*β) of the image data before compressed. The compressed image data is output to the display device for the display device to display the next picture (the nth frame of image). Then the displaying of the dynamic pictures is completed.

<Apparatus Embodiment>

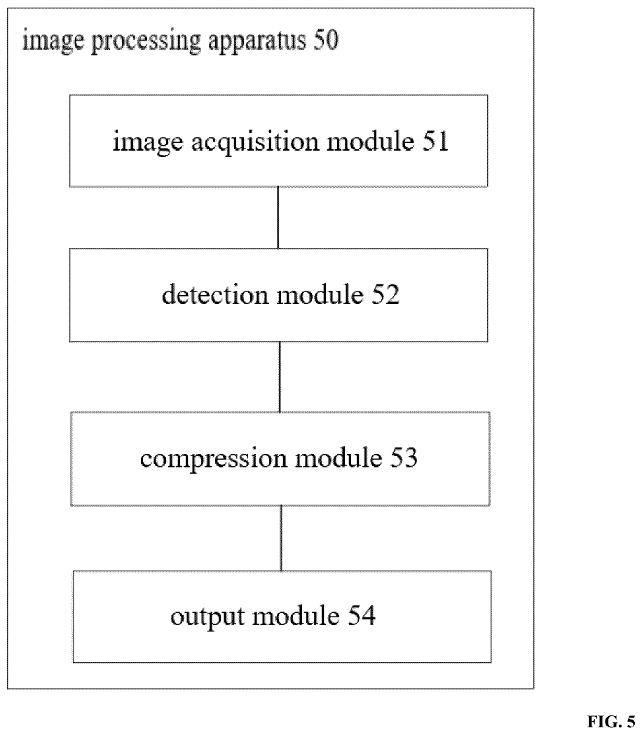

As shown in FIG. 5, the embodiment of the present disclosure provides an image processing apparatus 50, which comprises an image acquisition module 51, a detection module 52, a compression module 53 and an output module 54.

The image acquisition module 51 is for acquiring a current frame of image.

The detection module 52 is for detecting a moving object in the current frame of image to obtain a region of interest and a background region, wherein the region of interest includes the moving object.

The compression module 53 is for compressing image data of the region of interest to obtain first image data after compressed.

In an embodiment of the present disclosure, the compression module 53 is specifically for acquiring a target compression ratio.

In this embodiment, the step of acquiring the target compression ratio may comprise: determining the target compression ratio according to a preset compression ratio.

In this embodiment, the step of acquiring the target compression ratio may further comprise: determining the target compression ratio according to a moving speed of the moving object.

The compression module 53 is also specifically for compressing the image data of the region of interest according to the target compression ratio to obtain the first image data after compressed.

In a more specific example, the target compression ratio comprises a transverse compression ratio and a longitudinal compression ratio. The compression module 53 is also specifically for compressing the image data of the region of interest according to the transverse compression ratio and the longitudinal compression ratio to obtain the first image data after compressed.

In an embodiment of the present disclosure, the compression module 53 is also specifically for extracting a plurality of pixel points in the region of interest according to a preset extraction rule; and determining image data of the plurality of pixel points as the first image data after compressed.

The output module 54 is for outputting the first image data after compressed and the background picture data corresponding to the background region to the display device, so that the display device can display the current frame of image.

For continuous multiple frames of image including a moving object, the image acquisition module 51 is also for acquiring a next frame of image.

The detection module 52 is also for detecting the moving object in the next frame of image to obtain a region of interest and a background region, wherein the background region of the next frame of image is consistent with the background region of the current frame of image, and the moving object in the region of interest of the next frame of image changes.

The compression module 53 is also for compressing image data of the region of interest of the next frame of image to obtain second image data after compressed.

The output module 54 is also for outputting the second image data after compressed to the display device to display the next frame of image by the display device.

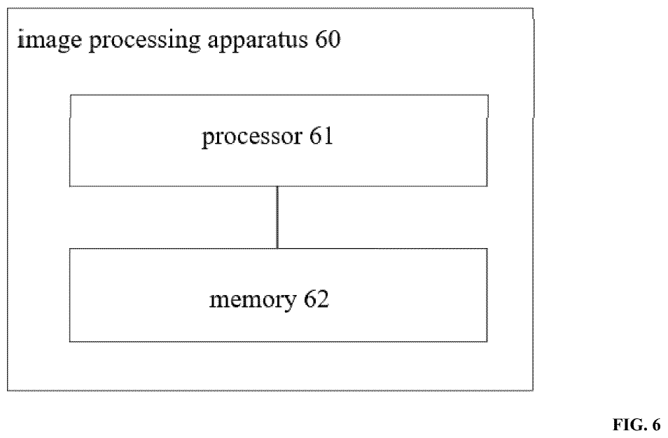

As shown in FIG. 6, the embodiment of the present disclosure provides an image processing apparatus 60, which comprises a processor 61 and a memory 62. The memory 62 is configured to store a computer program. When the computer program is executed by the processor 61, the image processing method disclosed by any of the preceding embodiments is implemented.

<Device Embodiment>

The embodiment of the present disclosure also provides an electronic device. The electronic device comprises an image processing apparatus.

In an embodiment, the electronic device may be the electronic device 100 as shown in FIG. 1. In an embodiment, the electronic device may be a virtual reality (VR) device, an augmented reality (AR) device, or a mixed reality (MR) device and other intelligent devices.

In an embodiment, the image processing apparatus may be either the image processing apparatus 50 shown in FIG. 5 or the image processing apparatus 60 shown in FIG. 6.

According to the embodiment of the present disclosure, by taking advantage of the characteristic of insensitivity of human eyes to local moving objects, the image data of the region of interest of the current frame of image is compressed, which can reduce the number of pixels of moving objects in the current frame of image, and can reduce the data amount for transmitting one frame of image data without affecting the visual effect of the human eye imaging, so that under the same transmission and processing bandwidth constraints, the display frame rate can be improved, the user's dizziness to VR motion image display can be reduced, and the user experience can be improved.

According to the embodiment of the present disclosure, when presenting continuous dynamic pictures to the user, the image data of the region of interest of the next frame of image is compressed, and only the compressed image data of the region of interest is output, which can further reduce the number of pixels of the image, and can reduce the data amount for transmitting continuous multiple frames of image data without affecting the visual effect of the human eye imaging, so that under the same transmission and processing bandwidth constraints, the display frame rate can be improved, the user's dizziness to VR motion image display can be reduced, and the user experience can be improved.

<Computer-Readable Storage Medium>

The embodiment of the present disclosure also provides a computer-readable storage medium on which computer instructions are stored. The image processing method according to the embodiment of the present disclosure is executed when the computer instructions are executed by a processor.

The embodiments in the present disclosure are described in a progressive manner. The same or similar parts of the embodiments may be referred by each other. Each embodiment focuses on the differences from other embodiments, but it would be clear to those skilled in the art that the above embodiments can be used separately or in combination as required. In addition, as for the apparatus and device embodiments, since they correspond to the method embodiments, their description is relatively simple, and relevant parts may refer to the description of the method embodiments. The system embodiment described above is only schematic, and the modules described as separate components may or may not be physically separated.

The present disclosure may be a system, a method and/or a computer program product. The computer program product may include a computer-readable storage medium loaded with computer-readable program instructions thereon for processor to execute various aspects of the present disclosure.

The computer-readable storage medium may be a tangible device capable of holding and storing instructions used by the instruction executing device. The computer-readable storage medium may be, but not limited to, for example, electrical storage devices, magnetic storage devices, optical storage devices, electromagnetic storage devices, semiconductor storage devices or any random appropriate combinations thereof. More specific but non-exhaustive examples of the computer-readable storage medium include: portable computer disk, hard disk, random-access memory (RAM), read-only memory (ROM), erasable programmable read-only memory (EPROM or flash), static random access memory (SRAM), portable compact disk read-only memory (CD-ROM), digital versatile disk (DVD), memory stick, floppy disk, mechanical coding device, such as a punched card or an emboss within a groove storing instructions, and any suitable combinations thereof. The computer-readable storage medium used herein is not interpreted as a transient signal itself such as radio wave or other freely propagated electromagnetic wave, electromagnetic wave propagated through waveguide or other transmission medium (such as optical pulses passing through fiber-optic cables), or electric signals transmitted through electric wires.

The computer-readable program instructions described herein may be downloaded from the computer-readable storage medium to various computing/processing devices, or to external computers or external storage devices via a network such as the Internet, local area network, wide area network and/or wireless network. The network may comprise copper transmission cables, optical fiber transmission, wireless transmission, routers, firewalls, switches, gateway computers and/or edge servers. The network adapter or network interface in each computing/processing device receives computer-readable program instructions from the network, and forwards the computer-readable program instructions for storage in the computer-readable storage medium of each computing/processing device.

The computer program instructions for executing the operations of the present disclosure may be assembly instructions, instructions of instruction set architecture (ISA), machine instructions, machine-related instructions, microcodes, firmware instructions, state setting data, or a source code or target code written by any combinations of one or more programming languages. the programming languages include object-oriented programming languages, such as Smalltalk, C++, and conventional procedural programming languages, such as “C” language or similar programming languages. The computer-readable program instructions may be completely or partially executed on the user computer, or executed as an independent software package, or executed partially on the user computer and partially on the remote computer, or completely executed on the remote computer or the server. In the case where a remote computer is involved, the remote computer may be connected to the user computer by any type of networks, including local area network (LAN) or wide area network (WAN), or connected to an external computer (such as via the Internet provided by the Internet service provider). In some embodiments, the electronic circuit is customized by using the state information of the computer-readable program instructions. The electronic circuit may be a programmable logic circuit, a field programmable gate array (FPGA) or a programmable logic array (PLA) for example. The electronic circuit may execute computer-readable program instructions to implement various aspects of the present disclosure.

Various aspects of the present disclosure are described herein with reference to the flow chart and/or block diagram of the method, device (system) and computer program product according to the embodiments of the present disclosure. It should be understood that each block in the flow chart and/or block diagram and any combinations of various blocks thereof may be implemented by the computer-readable program instructions.

These computer-readable program instructions may be provided to the processing unit of a general purpose computer, a dedicated computer or other programmable data processing devices to generate a machine, causing the instructions, when executed by the processing unit of the computer or other programmable data processing devices, to generate a device for implementing the functions/actions specified in one or more blocks of the flow chart and/or block diagram. The computer-readable program instructions may also be stored in the computer-readable storage medium. These instructions enable the computer, the programmable data processing device and/or other devices to operate in a particular way, such that the computer-readable medium storing instructions may comprise a manufactured article that includes instructions for implementing various aspects of the functions/actions specified in one or more blocks of the flow chart and/or block diagram.

The computer-readable program instructions may also be loaded into computers, other programmable data processing devices or other devices, so as to execute a series of operational steps on the computers, other programmable data processing devices or other devices to generate a computer implemented process. Therefore, the instructions executed on the computers, other programmable data processing devices or other devices may realize the functions/actions specified in one or more blocks of the flow chart and/or block diagram.

The accompanying flow chart and block diagram present possible architecture, functions and operations realized by the system, method and computer program product according to the embodiments of the present disclosure. At this point, each block in the flow chart or block diagram can represent a module, a program segment, or a portion of the instruction. The module, the program segment or the portion of the instruction includes one or more executable instructions for implementing specified logic functions. In some alternative implementations, the function indicated in the block can also occur in an order different from the one represented in the drawings. For example, two continuous blocks actually can be executed in parallel, and sometimes they may also be executed in a reverse order depending on the involved functions. It should also be noted that each block in the block diagram and/or flow chart, and any combinations of the blocks thereof can be implemented by a dedicated hardware based system for implementing specified functions or actions, or a combination of the dedicated hardware and the computer instructions. It is well known to those skilled in the art that implementation by hardware, implementation by software, and implementation by a combination of software and hardware are all equivalent.

The embodiments of the present disclosure have been described above in an illustrative and non-exhaustive manner. The present disclosure is not limited to the embodiments disclosed herein. Various modifications and changes will be apparent to those skilled in the art without departing from the scope and spirit of the embodiments. The choice of terms used herein is intended to best explain the principles, practical applications, or technical improvements of the embodiments, or to enable other skilled persons in the art to understand the embodiments disclosed herein. The scope of the present disclosure is defined by the appended claims.

The embodiments in this specification are described in a parallel or progressive manner. Each embodiment focuses on the differences from other embodiments. The same or similar parts of each embodiment may be referred by each other. As for the apparatus and devices disclosed in the embodiments, since they correspond to the methods disclosed in the embodiments, their description is relatively simple, and relevant parts may refer to the description of the method part.

Those skilled in the art will also understand that the units and algorithm steps of the examples described in conjunction with the embodiments disclosed herein can be implemented in electronic hardware, computer software or a combination thereof. In order to clearly illustrate the interchangeability of hardware and software, the composition and steps of the examples have been generally described in the above description according to functions. Whether these functions are implemented in hardware or software depends on the specific application and design constraints of the technical solution. Those skilled in the art may use different methods to realize the described functions for each specific application, but such realization shall not be considered beyond the scope of the present disclosure.

The steps of a method or algorithm described in conjunction with the embodiments disclosed herein may be directly implemented by hardware, by software module executed by a processor, or by a combination of hardware and software. The software module may be placed in a random access memory (RAM), an internal memory, read only memory (ROM), an electrically programmable ROM, an electrically erasable programmable ROM, a register, a hard disk, a removable disk, a CD-ROM, or any other form of storage medium known in the art.

It should also be noted that, relational terms such as first and second used herein are only to distinguish one entity or operation from another, and do not necessarily require or imply that there is such actual relationship or order among those entities or operations. Moreover, the terms “comprise”, “include” or any other variants are intended to cover non-exclusive inclusion, so that the process, method, article or apparatus including a series of elements may not only include those elements, but may also include other elements not stated explicitly, or elements inherent to the process, method, articles or apparatus. Without more limitations, an element defined by the phrase “comprising a . . . ” does not exclude the case that there are other same elements in the process, method, article or apparatus including the element.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An image processing method, comprising the following steps:
acquiring a current frame of image;
detecting a moving object in the current frame of image to obtain a region of interest and a background region, wherein the region of interest includes the moving object;
compressing image data of the region of interest to obtain first image data after compressed; and
outputting the first image data after compressed and background picture data corresponding to the background region to a display device to display the current frame of image by the display device.

2. The method according to claim 1, wherein the step of compressing the image data of the region of interest to obtain the first image data after compressed comprises:
acquiring a target compression ratio;
compressing the image data of the region of interest according to the target compression ratio to obtain the first image data after compressed.

3. The method according to claim 2, wherein the step of acquiring the target compression ratio comprises:
determining the target compression ratio according to a preset compression ratio.

4. The method according to claim 2, wherein the step of acquiring the target compression ratio comprises:
determining the target compression ratio according to a moving speed of the moving object.

5. The method according to claim 2, wherein the target compression ratio comprises a transverse compression ratio and a longitudinal compression ratio, and the step of compressing the image data of the region of interest according to the target compression ratio to obtain the first image data after compressed comprises:
compressing the image data of the region of interest according to the transverse compression ratio and the longitudinal compression ratio to obtain the first image data after compressed.

6. The method according to claim 1, wherein the step of compressing the image data of the region of interest to obtain the first image data after compressed comprises:
extracting a plurality of pixel points in the region of interest according to a preset extraction rule; and
determining image data of the plurality of pixel points as the first image data after compressed.

7. The method according to claim 1, wherein after outputting the first image data after compressed and background picture data corresponding to the background region to a display device to display the current frame of image by the display device, the method further comprises:
acquiring a next frame of image;
detecting the moving object in the next frame of image to obtain a region of interest and a background region, wherein the background region of the next frame of image is consistent with the background region of the current frame of image, and the moving object in the region of interest of the next frame of image changes;
compressing image data of the region of interest of the next frame of image to obtain second image data after compressed; and
outputting the second image data after compressed to the display device to display the next frame of image by the display device.

8. An image processing apparatus, comprising:
an image acquisition module for acquiring a current frame of image;
a detection module for detecting a moving object in the current frame of image to obtain a region of interest and a background region, wherein the region of interest includes the moving object;
a compression module for compressing image data of the region of interest to obtain first image data after compressed; and
an output module for outputting the first image data after compressed and background picture data corresponding to the background region to a display device to display the current frame of image by the display device.

9. An electronic device comprising the image processing apparatus according to claim 8.

10. A computer-readable storage medium having computer instructions stored thereon, wherein the method according to claim 1 is implemented when the computer instructions are executed by a processor.

11. A computer-readable storage medium having computer instructions stored thereon, wherein the method according to claim 2 is implemented when the computer instructions are executed by a processor.

12. A computer-readable storage medium having computer instructions stored thereon, wherein the method according to claim 3 is implemented when the computer instructions are executed by a processor.

13. A computer-readable storage medium having computer instructions stored thereon, wherein the method according to claim 4 is implemented when the computer instructions are executed by a processor.

14. A computer-readable storage medium having computer instructions stored thereon, wherein the method according to claim 5 is implemented when the computer instructions are executed by a processor.

15. A computer-readable storage medium having computer instructions stored thereon, wherein the method according to claim 6 is implemented when the computer instructions are executed by a processor.

16. A computer-readable storage medium having computer instructions stored thereon, wherein the method according to claim 7 is implemented when the computer instructions are executed by a processor.
